(19) United States
(12) Patent Application Publication
(10) Pub. No.: US 2012/0019640 A1
(43) Pub. Date: Jan. 26, 2012

(54) CAMERA GUARANTEEING AUTHENTICITY OF VIDEOS OR PHOTOS TAKEN AND OF WHEN TAKEN AND OPTIONALLY OF ALL ADDITIONAL MEASURABLE FACTS OF THE CIRCUMSTANCES OF THE TAKEN VIDEOS OR PHOTOS

(76) Inventor: Spandan Choudury, (US)

(21) Appl. No.: 12/963,297

(22) Filed: Dec. 8, 2010

Related U.S. Application Data
(63) Continuation of application No. PCT/IB2009/052392, filed on Jun. 5, 2009.
(60) Provisional application No. 61/059,769, filed on Jun. 8, 2008.

(30) Foreign Application Priority Data
Jun. 5, 2009 (IB) PCT/IB2009/052392

(51) Int. Cl. H04N 7/18

(52) U.S. Cl. 348/61; 348/E05.025

(57) ABSTRACT

The invention is a camera that reasonably guarantees that videos or photos taken by it and presented are authentic videos or photos of the real world and that they were taken at a particular date and time, and therefore guarantees that those videos or photos are not tampered renditions of other genuine videos or photos, and that they have not been artificially generated either, and that they were taken at a particular date and time. The relevance of the invention is in the fact that it is otherwise difficult and sometimes impossible to determine if a photo or a video presented is genuine or fake or if the photo or video was really taken at a claimed date and time. Optionally, the device can also be extended to guarantee the authenticity of all additional claimed measurable facts of the circumstances of a particular photo or video (e.g. it will accurately authenticate the claimed geographical location or the claimed conditions of altitude or temperature or pressure or loudness or light or virtually anything else that can be measured). The core technology is a combination of a virtually impossible to replicate uniquely sealed embedded 3D hardware fingerprinting “mesh” internal to the core entireties of the camera, the use of “collision” free “secure-hash” encryption technology towards unique identity tag generation, a special form of distance detection, and specially authenticated mechanisms of input of time and of all other optionally measurable external circumstances specific to the video or photo, as the nucleic-, albeit not the only main, components. Any attempt to improperly access or tamper with the hardware internals or any stored video or photo data would result in a computed secure-hash identity tag totally different from that originally computed and was technically authenticated in the context of the hardware and/or specific video or photo data, immediately signaling tampering.

### CROSS REFERENCE TO RELATED APPLICATION

This continuation patent application claims the benefit of PCT International Application No. PCT/IB2009/052392 filed with RO/IB on 5 Jun. 2009 which is incorporated herein by reference in its entirety. (The aforementioned PCT International Application No. PCT/IB2009/052392 already claims the benefit of U.S. Provisional Patent Application No. 61/059,769, filed on 8 Jun. 2008 which is incorporated therein by reference in its entirety).

### FIELD OF INVENTION

The field of invention is cryptography, and in particular the unique identification of hardware and hence a detection of hardware tampering.

### BACKGROUND OF INVENTION

Today when a video or photo is presented either in a court of law, or in other legal proceedings, or in any other context the authenticity of the video or photo in either that they were not digitally or otherwise modified or that they were indeed taken at the claimed date or time cannot be guaranteed. Therefore, when necessary, extensive tests costing huge sums of money are spent attempting to analyze the video or photo to ascertain claims of authenticity, and even then a near 100% degree of certainty of authenticity is never achieved, other than using corroborating evidence if available.

This invention solves this problem permanently and inexpensively. Any video or photo taken with this camera would be guaranteed to be authentic and to have been definitely taken at the claimed date and time.

That would eliminate the waste of billions of dollars on expensive analysis of a video or photo, and enable a near 100% degree of certainty of authenticity. That would not only make the judicial system run faster, it has the potential of rendering society itself better, with the knowledge that the truth cannot be easily twisted or otherwise compromised.

### SUMMARY OF INVENTION

The following would be the key parts of the device—
1. A secure hardware mesh (SMH) with precisely computable electronic properties that would be unique to that mesh, whose electronic property can be taken a unique “signature” of using one or more “collision free” secure hash algorithms—SHA 512, TIGER 160, Whirlpool 2, RIPEMD 320, etc. That wire mesh would be integrated into the body of the camera, encompassing all of the critical camera components inside it. It would be impossible to physically access any of the internal components of the camera without physically “tearing” the mesh somewhere, resulting in a different secure hash computed signature for that mesh, reflecting tampering. The battery would, for some of the models, be outside the mesh, so it can be replaced without altering the hash code.
   The wire mesh and the camera's Serial Number would be part of a digital signature and digital encryption mechanism based on PKI (Public Key Infrastructure), that would verify that the images and videos generated in the camera are the not tampered renditions of the original images and videos, and that they have been generated by a specific camera.
2. An authenticated time and date clock would be part of the components placed in the space enclosed by the mesh. That clock cannot be ordinarily set, but can be remotely set by authorized servers over an encrypted Internet link. Optionally, the camera can be set over an encrypted wireless channel by a separate portable device that itself would be set remotely over the Internet by those authorized servers. All other optional devices, e.g. a GPS, temperature sensor, pressure sensor etc. would be similarly housed physically inside the mesh enclosed space, and could only be accessed and set over the secure channel by that external device or securely over the Internet by the remote servers. The purpose of the separate device is to allow the camera internals to be set authenticated when away from the Internet.
3. Adequate flash memory inside the mesh enclosed space to store image/video data, machine code, identity related data, etc.

### SUMMARY OF DIAGRAMS

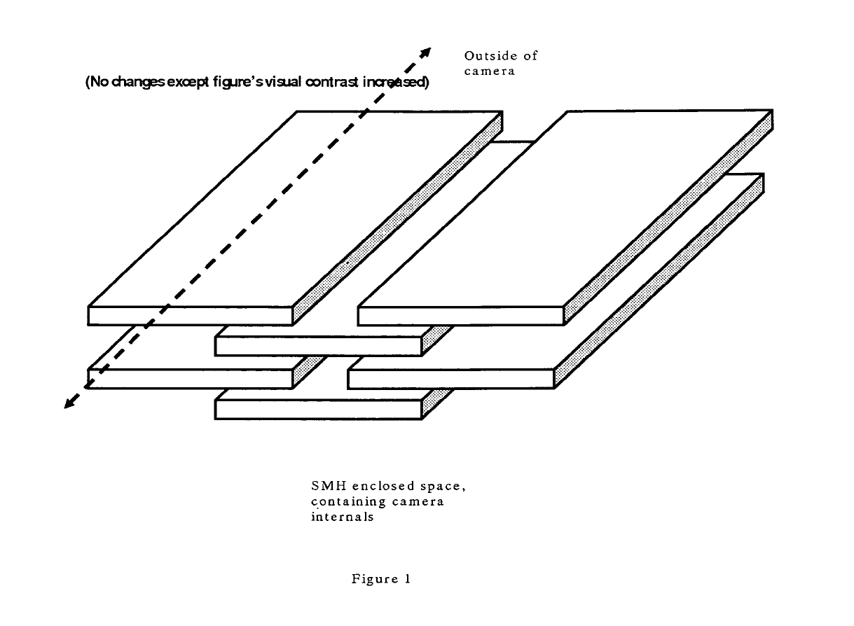

FIG. 1 A cross section of an example of a secure hardware mesh (SMH) showing the interlaced, base gap “phase shifted” layers of the embedded ultra thin conducting wire (UTCW) strands whereby no straight line through intra-UTCW spaces exists between any intra-UTCW space in the outmost UTCW layer and an intra-UTCW space in the innermost UTCW layer. The dashed line shows the axis direction of the UTCW strands in the figure. The UTCW layers shown would encompass SMH enclosed space from all directions. Note the insulating (against mechanical, and/or electrical, and/or electromagnetic, and/or other signals) filler gaps vertically and horizontally around each UTCW strand, to prevent a short (hence prevent an erroneously altered C-HCM) and/or tamper with mechanical and/or non-mechanical (e.g. electrical, and/or electromagnetic, and/or other) signals. However, unlike in the image, the axes of the UTCW strands don't all need to be in the same direction or be in distinct layers. They could be in random directions and in no distinct layers, such that the end effect is still that no straight line through intra-UTCW spaces would exist between any intra-UTCW space in the outmost UTCW zones and an intra-UTCW space in the innermost UTCW zones.

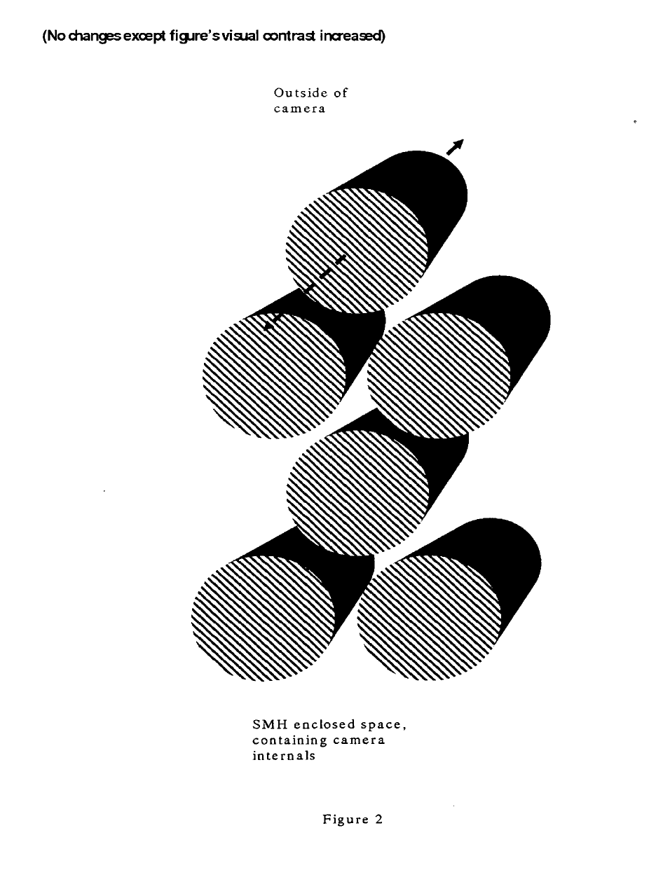

FIG. 2 An alternative example of a cross section of a secure hardware mesh (SMH) showing the interlaced, gap “phase shifted” layers of the embedded ultra thin conducting wire (UTCW) strands whereby no straight line through intra-UTCW spaces exists between any intra-UTCW space in the outmost UTCW layer and an intra-UTCW space in the innermost UTCW layer. The dashed line shows the axis direction of the UTCW strands in the image. The UTCW layers shown would encompass SMH enclosed space from all directions. Again, unlike in the image, the axes of the UTCW strands don't all need to be in the same direction or be in distinct layers. They could be in random directions and in no distinct layers, such that the end effect is still that no straight line through intra-UTCW spaces exist between any intra-UTCW space in the outmost UTCW zones and an intra-UTCW space in the innermost UTCW zones

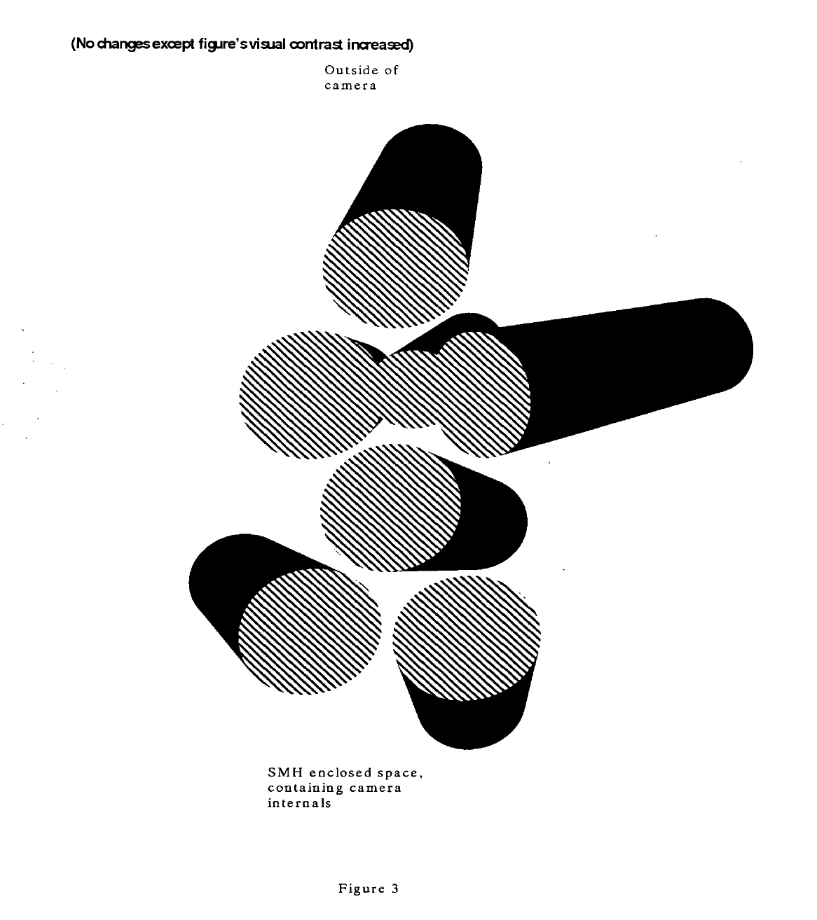

FIG. 3 SMH cross section shown is an example of random axes UTCW, whereby no straight line through intra-UTCW spaces exists between any intra-UTCW space nearest the outside and any intra-UTCW space nearest SMH enclosed space containing the camera internals. The TBSE units connected to the UTCW strands will be either embedded inside the intra-UTCW gaps, or be preferably in SMH enclosed space.

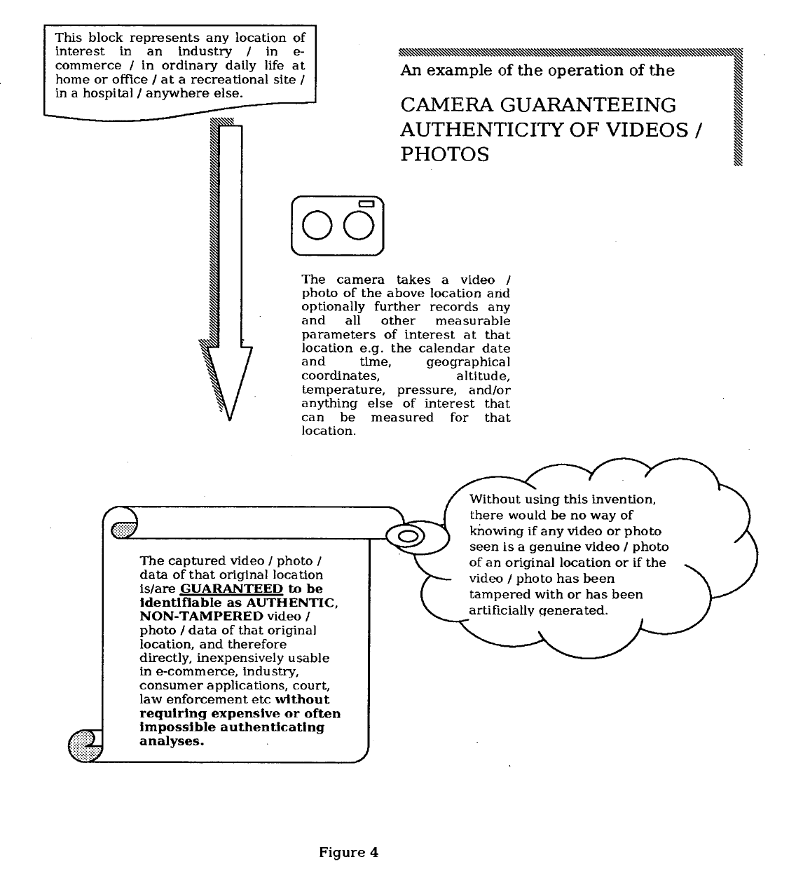

FIG. 4 An example of the operation of the invention is depicted.

### DESCRIPTION OF EMBODIMENTS OF INVENTION

1. A PKI (Public Key Infrastructure) based data authentication is used.
2. All video, photo and other data content in the camera would be tagged (i.e. digitally signed) with a combination of a private key (stored within the camera's hardware mesh enclosed space) assigned by the manufacturer to the Serial Number of the product piece and the uniquely computable electronic property (henceforth called UCEP) of the secure hardware mesh (henceforth called SMH, refer to subsection “The secure hardware mesh (SMH)”). All data associated with the video or photo, namely time and date, temperature, pressure, light conditions etc. would be similarly digitally signed. The aforesaid associated data of date, time, pressure, light conditions etc. would not only be part of the indirect image/video authentication mechanisms but would also assist in understanding and analyzing an image more meaningfully when used in a court of law or for other lawful investigations.
   Consider the example of an image or a video taken by the camera and stored in its memory along with the associated data on time and date, GPS coordinates, temperature, and other data. The chip firmware would compute a secure hash message digest (henceforth called HCD) of the full image/video data (that will already have been associated with time stamps, GPS, temperature, pressure and other environmental data, all collected by the camera's tamper-proof onboard accessories within SMH space) using a selected “collision free” algorithm (SHA 512, TIGER 160, WHIRLPOOL 2, RIPEMD 320, etc). Then the “collision free” algorithm based secure hash message digest (henceforth called HCM) of UCEP of the encompassing SMH is recomputed (call that recomputed UCEP C-UCEP, and the corresponding recomputed HCM C-HCM)—this is done each time a new video or photo is taken. Call the original (i.e. stored on chip as being the last known authenticated) UCEP S-UCEP and the corresponding HCM S-HCM. At this stage a comparison is made between S-HCM and C-HCM, and if the values don't match then a “Tamper Alert” flag (which would typically be one or more changeable bit(s) signifying the nature of corruption of SMH, forming one or more byte(s)) is raised, to be subsequently included in the final string that is to be securely embedded within the digital signature. Next, these two hash codes would be concatenated (i.e. the fixed length HCD string would simply be appended at the end of the fixed length C-HCM string), and the fixed length “Tamper Alert” byte(s) inserted in between C-HCM and HCD would be suitably set if a tamper is detected (i.e. if C-HCM S-HCM) and not set otherwise (i.e. if C-HCM==S-HCM, in which case the byte(s) would be set to “0” indicating no tamper)—call that resultant concatenated string DSG.
   DSG would then be encrypted with a private key that would typically be a logical concatenation of S-UCEP and another key (henceforth called PK2) corresponding to the Serial Number of the product item, each of which would remain secret to the camera and known only to the manufacturer and/or optionally to the Registration Authority (RA) and/or a Certifying Authority (CA)−albeit awareness of UCEP and PK2 by a CA/RA is not entirely recommended to minimize distribution of the private key and therefore to reduce the risks of accidental disclosure in the future. That encrypted value will be the digital signature of the image or video.
   When an image needs to be verified for authenticity, the manufacturer assigned public key (MAPUK)—that would typically be a function of the item's Serial Number and S-HCM—for the camera would be used on the digital signature to attempt to decrypt it. If it successfully decrypts (revealing DSG) then the signature, and hence the associated image or video, was authentically created by the specific camera at issue. If DSG string has a raised “Tamper Alert” flag then that would indicate that SMH has been tampered with. Then to verify that the image/video is unchanged from what the camera originally captured, the secure hash message digest code of the image/video data is generated and compared to the corresponding counterpart of DSG. If they match, the image/video has not been changed.
3. The relevance of SMH is that even when an ultra-narrow probe is passed through it—consequently severing even just one of the ultra thin conducting wires embedded in SMH—attempting to access the contents of the camera internals, C-HCM computes completely differently, therefore immediately raising a “Tamper Alert” for that particular image/video.
4. When the customer prefers the option of additional authenticity verification, the MAPUK (i.e. typically a concatenation of S-HCM and Serial Number, or an alternative function thereof), to verify its (i.e. MAPUK's) authenticity, along with other information on the camera and/or customer purchasing that camera and an expiry date, would be integrated and encrypted by the CA and/or RA (using the CA/RA's own private key) as a digital certificate that would also be rendered available along with the images and videos generated by the camera. That certificate can be decrypted by the designated public key of the CA and/or RA. A successful decryption would confirm that the certificate was created by the CA and/or RA, and that therefore the MAPUK embedded in that certificate is authentic. Furthermore, information on a revocation of the certificate (hence of MAPUK) prior to the stipulated expiry date can also be obtained by anyone by checking with the CA/RA.
5. As a yet additional option of security, the camera would entirely refuse to operate in terms of even capturing the image/video if C-HCM≠S-HCM. Optionally if C-HCM≠S-HCM then the camera could be set to still capture the image/video but also mandatorily encrypt the image/video with the private key that's a function of C-UCEP (not S-UCEP as earlier) and PK2. That would prevent the image from being decrypted at all if the MAPUK has not been updated to reflect C-HCM.
6. When the camera needs to be serviced, SMH would be broken, and after the servicing a new SMH sealed in, whose C-HCM is then generated and registered with the manufacturer/CA/RA, forming a new MAPUK that too is then registered with the CA/RA and a new digital certificate issued and the previous one revoked.

7. To maintain the integrity of the data, the user will not be able to directly set the internal clock or any of the other internal components of the camera; instead the mechanism to set the internals would be the following—
a. The camera would be securely connected to the Internet, either directly or optionally via an intermediate portable device (IPD), to an authorized server. The benefit of the IPD would be that it can be used by the camera to non-manually, authenticated, set the camera internals when the camera is away from the Internet and needs to be set.
b. The camera connects to the manufacturer's designated server, using PKI based digital signature and PKI data encryption (essentially using the same private keys and public keys listed above from the camera's end as well as the corresponding counterparts at the authorized server's end), and the internals are set by the server. A similar PKI based signature and encryption mechanism would be used for both setting the IPD over the Internet and then later to set the camera with the IPD.
8. The PKI connectivity would also allow the image/video data to be safely directly uploaded to the Internet or to other cameras or devices.
9. While SMH obviously cannot extend to the front of the lens or behind the lens before the image capture medium, instead the edges of the lens embedded inside the body of the camera would be integrated with SMH, so any attempt to remove or manually realign the lens would result in a “Tamper Alert”.
10. With image tampering within or stealing the identity of the camera virtually eliminated, the camera has features to reasonably eliminate image manipulation outside the camera. Towards that, one of the key features aimed at dissuading the misuse of the camera to capture static 2D photos or 3D movies projected on a regular 2D screen and fraudulently claiming them as photos or videos of real life 3D situations is the inclusion of a depth sensor (i.e. distance meter). Depending on the camera model, the depth sensor would be based on laser and/or radio waves, and would take the depths at multiple, micro-time spaced, random locations on the field of view of the image when the image/video is taken and/or just afterward. Alternatively, the depth sensor could also be in terms of comparing regular visual static (i.e. non-video) images taken from two different angles appropriately apart from extensions in the camera that would project on command, and with those comparative static images simultaneously taken at the same time the base image/video is itself taken and/or just afterwards.
11. The wire thickness and density of the conducting wires embedded in SMH would vary per the camera model. The thinner and more densely spaced the wires, the more secure the camera.
12. To minimize potential “unsecured” locations at the junctions where USB wires enter SMH-enclosed space, fully wireless communication between the camera and the outside world would be preferred, specific to the camera model. In such models, wires connecting the battery would be the only entities entering SMH space. In other camera models, for the maximum security, the battery too would be permanently sealed inside SMH space—such models would either operate securely for a limited time as “disposable” cameras, or the battery rechargeable by visible light, motion, EMF (electromagnetic field), heat, infrared light, UV (ultraviolet) light, or by other equivalent means that don't require a physical wire connection between the embedded battery and the source of recharging power outside. Optionally, in some models, the battery would be replaced by opening a preset “window” in SMH—that window would have the same UTCW layers through it as the rest of SMH and the junction between the window and rest of SMH would simply micro-connect differently each time the window is resealed after opening it, resulting in a different TBSE network (See “SMH” in “Particular considerations in invention”), that would result in new C-UCEP that would need to be reassigned as the new value of S-UCEP for purposes of the digital signature, until the next time the window is opened to replace the battery.
13. To prevent any attempts to break open SMH and reverse engineer the memory content in the chips to determine (the private key from) C/S-UCEP and PK2 stored therein as well as the message digest algorithm used (in order to generate fraudulent digital signatures (even if fraudulent digital certificates would still be impossible given that the private key of the CA/RA would still not be known)), certain camera models would be programmed to erase C/S-UCEP and PK2 upon detecting an SMH puncture. To prevent hackers from waiting to let the battery run dry in certain camera models where the battery would be inside SMH before attempting to break open SMH to reverse engineer the chips, the chips in some of those models would be designed to use the last available battery resources—when battery power falls below a specific threshold and not recharged to above that threshold within a time deadline—to erase C/S-UCEP and PK2. To prevent hackers from removing the battery in certain camera models where the battery is outside SMH prior to hacking (so as to try to prevent the chip from having the battery power to erase C/S-UCEP and PK2), some of those camera models (with battery outside SMH) will have a low power reserve battery internal to SMH that would do the job described above in this paragraph if a tamper is detected.

In each of these cases, including—albeit not necessarily—even if the on-chip embedded machine code has been partly or wholly erased—if there was no tamper associated with the battery's running dry, S-UCEP and PK2 values can be remotely updated (and the machine code re-embedded) onto the chip(s) using a combination of the product's Serial Number and a second hardware code (that would also be imprinted on the body of the camera and which would not otherwise be used for purposes of PKI digital signature generation or PKI encryption) over the Internet by securely connecting to an authorized server. However, as an optional security procedure, in certain camera models such re-implanting of S-UCEP and PK2 and/or the onboard machine code would not be allowed to prevent a hacker from deliberately leaving SMH broken (i.e. unsealed) prior to re-implanting, with/without having already also tampered with other camera internals like the lens, etc. and/or having partly/wholly corrupted/erased the machine code—for those models it would be required to produce the physical camera to an authorized service representative to check for tamper and it would be that service representative who would then connect the camera to a secure platform to re-implant S-UCEP, PK2 and/or the machine code.
14. An additional feature option towards date and time stamping would be to allow DSG of each selected image/video to be transferred over a connection via a mobile/satellite phone and/or via the Internet to designated trusted remote servers where each DSG would be given a date and time stamp and stored. Since collision free message digests cannot be reverse engineered, the time stamped DSG strings at those designated, trusted servers would prove the existence of the image/video data associated with those DSGs at times at least as early as no later than the corresponding times stamped at the designated servers. That would allow an additional layer of authenticated time stamping without needing to export the actual image/video data to the stated designated servers.
   All appropriate additional obvious variations of each of the above are included in the scope of this patent application.
   FIG. 4 may be noted.

### The Secure Hardware Mesh (SMH)

This is a primary component of the product. It would essentially comprise of the following—
a. A highly rigid, non-flexible, non-electrically-conducting base of polymer(s), ceramic(s) and/or composites.
b. Ultra-thin conducting wires (call each an UTCW) embedded in that rigid, non-flexible polymer/ceramic/composite base, such that the UTCW strands are microscopically spaced apart at distances less than the thickness of an UTCW, and connected only with a reasonably large count of appropriate transistor based semiconducting entities (call each a TBSE). The semiconducting entities do not necessarily need to be embedded physically within the base, just connected with the UTCW strands, and can and should preferably remain within the space enclosed by SMH in order to not adversely affect the key function of the UTCW strands by way of increasing intra-UTCW spaces in the base around TBSE embedded nearby.
c. Each TBSE will communicate with appropriate among the other TBSEs to form a complex network that require each of the UTCW strands to function. The complete TBSE network creates a large connectivity data set (CDS), on which UCEP is computed.
d. When even one UTCW strand is broken, resulting in even one bit of the CDS to change, C-UCEP is automatically entirely different.
e. The UTCW strands will be implanted in the base as three or more “phase shifted” micro-spaced UTCW layers, such that no straight line through intra-UTCW spaces exists between any intra-UTCW space in the outmost UTCW layer and an intra-UTCW space in the innermost UTCW layer, forming a virtually impermeable UTCW wall in SMH. Hence, when even an ultra-micro probe of thickness equal to or greater than that of the UTCW thickness is passed through SMH, it would result in severing at least one UTCW strand, that would result in a TBSE detecting a micro-disconnection, resulting in an equivalently microscopically altered CDS, which in turn would result in a COMPLETELY DIFFERENT C-UCEP, resulting in the corresponding completely different (from S-HCM) C-HCM, raising a “Tamper Alert” in DSG stored in the digital signature.
f. An optional flexible base could also be considered but not preferred to minimize security vulnerability from one or more UTCWs flexing instead of breaking when a micro-probe is passed. Sufficiently increasing UTCW strand count density in that (flexible) base would reasonably counter that shortcoming. The benefit of a flexible base is in its speedier installation, and therefore the rigid or flexible base selection will be per a cost-benefit (from the application perspective) analysis specific to the camera model.
g. Since the thinner the UTCW strands the thinner needs be the microprobe to be able to even meaningfully attempt to pass through SMH, the thickness of the UTCW strands would be varied specific to the product model.
h. No extraordinary care would need to be taken for creating a unique TBSE network for each camera unit. Upon cutting out from an SMH sheet and joining the edges, each SMH shell would automatically have a unique UTCW connected TBSE network, that would result in a unique S-HCM, towards a digital signature that would be unique to each individual camera unit.
i. The medium of the intra-UTCW space (i.e. the stated rigid plastic/ceramic/composite base) as well as the UTCW itself would be made of material that would support an electronic logical “severance” (e.g. by way of using material whose electrical conductivity properties change very significantly (e.g. by way of markedly, permanently raising its electrical impedance)) at the slightest direct pressure—resulting in an effective logical permanent “severance” of an UTCW even though it might not be actually physically broken when a probe is attempted to be passed through SMH. To prevent false positives for pressure-sensitive UTCW material, the base material would be sufficiently rigid to disallow pressure applied on the outside surface of SMH from being easily transferred to UTCW strands (and the base) inside and hence misinterpreted by the UTCW as pressure. Towards that objective, optionally, semiconducting ceramics and non-ceramics would also be a consideration for either the base material and/or the UTCW itself.
   However, in select camera models, for a more definitive determination of an actual full breach (rather than a partial or attempted breach) of SMH, the UTCW strands would be connected to the TBSE units (in layered (rather than randomly laid) UTCW SMH's) such that only when one or more UTCW's is/are breached in each of the UTCW layers would a “Tamper Alarm” be raised. However, this is not really necessary.
j. The TBSE units connected to the UTCW strands should preferably not be embedded within the polymer/ceramic/composite base, to eliminate the gaps that could otherwise be caused (depending on the relative intra-UTCW spaces and the sizes of the TBSE units) between the UTCW strands thereby potentially adversely affecting the ability of the UTCW strands to detect micro-probes. Instead, the TBSE units should preferably remain in the space enclosed by SMH, while connected to the UTCW strands of course.
   All appropriate additional obvious variations of each of the above are included in the scope of this patent application.
   FIG. 1, FIG. 2 and FIG. 3 may be noted.

### Proof of Feasibility, Tangibility and Concreteness

The proof of feasibility is self evident from the specifications.

The proof of tangibility is in the very significant authentication capabilities achieved with the product's specifications.

The proof of concreteness is in the unambiguous specifics.

### Special Advantages of Invention

Among the special advantages of the product are—
1. No extraordinary care would need to be taken to electronically connect SMH's TBSEs via the UTCW strands. The UTCW strands and TBSE units would be connected completely randomly at SMH sheets during (SMH sheet) manufacture, so when an SMH shell is assembled for each camera the resulting digital signature would automatically be unique, as would be the new digital identity of the camera each time SMH is even microscopically tampered.
2. The UTCW and TBSE mechanism can be extended to render virtually any device, or any space tamper proof.
3. How is this camera better than simply using a pressure and/or other) sensitive material as a shell surrounding the camera internals?
   a. An ordinary shell can be easily broken into, the camera internals tampered with, and then the shell fraudulently replaced, all with no visible trace of the tamper.
   b. An ordinary shell would not make available a signature associated with the image/video data to adequately definitively confirm whether or not the image/video data came from a particular camera and whether the camera has been tampered with.
   c. Attempting to integrate the digital signature (and digital encryption) mechanism in a camera that would just have a touch/pressure sensitive shell would make the system lack the precise thresholds necessary to reasonably identify a tamper, resulting in either too many more false positives or false negatives than would happen with an SMH based system. Furthermore such a system without an SMH would also prevent generating a digital signature as secure as with an SMH.

### Legal

If any sub-component of the plurality of technologies in “A.” through “H.” of Claim #1 of this patent application is already (or will be) patented (where such patents is/are or will be valid (i.e. not (to be) expired, withdrawn, etc)) by other than this inventor/applicant (and/or by other than any future assignee(s) on this invention) then the scope of such aspects of Claim#1 and of any dependence by other claim(s) in this patent application to such aspects of Claim #1, only when such technology/technologies is/are used per this claim, would be, in lawful reasonableness, as new use and/or improvement use. Any and all item(s) that might be listed in this patent application, on which intellectual property right(s) (including, but not limited to, patent(s), trademark(s), service mark(s), copyright(s), etc.) is/are currently already owned by, and/or by other than, this inventor/applicant (and/or by any future assignee(s) on this invention) is/are just that—its/their current intellectual property ownership is as currently listed in the appropriate lawful official database(s) on such intellectual property ownership.

What are claimed are:

1. A prophetic invention comprising of a camera that will capture images and/or videos (along with any associated data on GPS, temperature, pressure and other surroundings information) that (images and/or videos along with any associated data) can subsequently be guaranteed to be identifiable as being authentic images and/or videos along with any authentic associated data of ACTUAL real life scenarios/locations/objects and (therefore) as being NEITHER artificially created (images and/or videos along with any associated data) NOR being tampered (images and/or videos along with any associated data); The camera achieves this objective with its features that comprise of the following—
A.
SMH
This would be the unique, non-duplicable, typically randomly created/installed secure hardware mesh made of fine Ultra Thin Conducting Wires (UTCW) that would surround the entire internals of the camera device; The SMH would be embedded with, or otherwise connected to, a large count of Transistor Based Semiconductor Entity (TBSE) units; The SMH would be a highly delicate (hence easily broken if a “break in” into the camera internals is attempted), virtually impermeable (hence probes cannot essentially be “sneaked through” it without breaking one or more UTCW wires, hence altering the overall mesh), conducting “net” embedded into the outer shell (or an appropriate outer layer inside the shell) of the camera; The very large count of transistors/TBSE units (along with other necessary standard accessory electronic components, e.g. capacitor(s), resistor(s), etc to allow the mesh to function) embedded in (or otherwise connected to) it at appropriate points of the entire mesh would result in a digital Uniquely Computable Electronic Property (UCEP) of the SMH; Any attempt to get at the internals of the camera, even with microscopically ultra-thin physical, laser or other probes would result in damage to one or more strands of the UTCW of the SMH resulting in a change in the UCEP (and hence HCM (see below));
UCEP
This is the digital Uniquely Computable Electronic Property of the SMH; Since the SMH (with TBSE connections) for each camera device would be unique, so would the UCEP (be unique); The originally computed UCEP on a particular SMH would be labeled S-UCEP, and a recomputed UCEP would be labeled C-UCEP;
HCM
This is the secure hash digest, computed using a selected collision-free algorithm (e.g. SHA 512, TIGER 160, RIPEMD 320, WHIRLPOOL 2, etc) on the contents of the (digital) UCEP; The HCM would be recomputed each time a new video/image (along with any associated data) is captured by the camera; An original HCM is labeled S-HCM; the corresponding original UCEP is labeled S-UCEP; A recomputed HCM is termed C-HCM; the corresponding recomputed UCEP is labeled C-UCEP;
HCD
Secure hash digest, computed using the selected collision-free algorithm (e.g. SHA 512, TIGER 160, RIPEMD 320, WHIRLPOOL 2, etc) on the digital contents of an image/video (along with any associated data); The HCD would be recomputed each time a new video/image (along with any associated data) is captured by the camera; An original HCD on a particular video/image (along with any associated data) would be labeled S-HCD; A recomputed HCD on that supposedly (i.e. purportedly) same video/image (along with any associated data) would be termed C-HCD;
DSG
This would be the Digital Signature of a particular video/image (along with any associated data), comprising of the following items (and ordinarily in this sequence):
C-HCM, “Tamper Alert” byte ('0′ if no tamper of the SMH is detected, i.e. when S-HCM==C-HCM, ‘1’ otherwise), HCD;
PK2
A private key corresponding to the Serial Number of the camera device, kept digitally secret inside the camera device and known typically only to the manufacturer (and/or optionally also to the RA (Registering Authority)/CA (Certifying Authority));
Private key to encrypt DSG
This PKI (Public Key Infrastructure) based key would be used to encrypt the DSG, and would be a function of S-UCEP and PK2; The private key would be kept secret inside the camera device and would be known typically only to the manufacturer (and/or optionally also to the RA/CA);
MAPUK
This would be the PKI based Manufacturer Assigned PUblic Key for the camera device, and would typically be a function of the S-HCM and the Serial Number; The MAPUK is to be used to try to decrypt the encrypted output of the encryption of a DSG by the aforementioned “Private key to encrypt DSG”, to determine the authenticity of the DSG; If the stated encrypted output can be successfully decrypted with the MAPUK (revealing DSG), then the DSG would be deemed authentic, and hence it can be concluded that the corresponding video/image (along with any associated data) was captured by the corresponding camera; However, the successful decryption of an encrypted DSG with MAPUK does not in and of itself prove if the corresponding camera has or hasn't been physically tampered with, which determination would be made from the value of the “Tamper Alert” flag embedded within the DSG; In some camera models for additional security the MAPUK would itself be encrypted by the CA and/or RA (using the CA/RA's own private key) as a digital certificate that would also be rendered available along with the images and videos (along with any associated data) generated by the camera—that certificate can be successfully decrypted by the designated public key of the CA and/or RA to generate the MAPUK for its use as aforementioned; In some camera models, as an added security option if C-HCM≠S-HCM the camera would refuse to even capture new image/video data (along with any associated data); In some camera models, as an added security option combined with convenience, the camera would continue to capture new image/video data (along with any associated data) if C-HCM≠S-HCM but the captured data would fail to be decrypted unless MAPUK is updated to reflect C-HCM (and not S-HCM as ordinarily) where the private key is defined as a function of C-UCEP (and not S-UCEP as ordinarily) and PK2;
TBSE
This would be a Transistor Based Semiconductor Entity embedded into, or otherwise connected to, the SMH, which (TBSE) could be of any design based on transistor(s), such that its ON/OFF status following an input signal can be specifically determined (i.e. measured/identified); The relative positioning of the entire TBSE group in any SMH will typically effectively be random and therefore will always be unique; And because the ON/OFF status of each TBSE unit can be specifically determined, and because the positioning of the TBSE group in the SMH would be unique for any SMH—resulting in a unique connectivity data set (CDS)—the UCEP for the SMH can be uniquely computed;
UTCW
These are the Ultra Thin Conducting Wires connected to a large count of TBSE units that make up the SMH; If any UTCW strand is damaged, the resulting disconnection among the embedded or otherwise connected TBSE units would result in a computed UCEP (C-UCEP) value that would be different from the original UCEP (S-UCEP) value for that SMH; The thickness and density of each strand in the UTCW would vary per the camera model—the thinner and more densely spaced the wires, the more secure the camera;
B.
The edges of the lens embedded inside the body of the camera would be appropriately integrated with the SMH, so any attempt to remove or manually realign the lens would result in a “Tamper Alert”;
C.
In some camera models, to minimize potential physically “unsecured” locations at the junctions where, for example, USB wires would ordinarily enter the SMH-enclosed space, fully wireless communication between the camera and the outside world would be implemented, specific to the respective camera models; In such models, wires connecting the battery would be the only entities entering the SMH-enclosed space; In some camera models, for greater security, the battery too would be permanently sealed inside the SMH-enclosed space; In some camera models, the battery would be replaced (i.e. changed when the battery runs dry, for example) by opening a preset “window” in the SMH—that window would have the same UTCW layers through it as the rest of the SMH and the junction between the window and rest of the SMH would simply micro-connect differently each time the window is resealed after opening it, resulting in a different TBSE network, that would result in a new C-UCEP (hence a new C-HCM) that would need to be reassigned as the new value of S-UCEP (hence the new S-HCM) for purposes of the digital signature, until the next time the window is opened again;
D.
When the camera needs to be serviced, the SMH would be broken, and after the servicing a new encompassing SMH sealed, whose C-HCM is then generated and registered with the manufacturer/CA/RA (as the new S-HCM), forming a new MAPUK that too is then registered with the manufacturer/CA/RA and a new digital certificate issued and the previous one revoked;
E.
In some (most) camera models, to maintain the integrity of the data, the user will not be able to directly configure the internal clock or any of the other internal components of the camera—instead the camera's PKI based public and private key system will be used to securely connect (over the Internet or/and otherwise) to a remote authorized server that would configure the camera's internals; In some camera models, as an added operational convenience in this context for when the camera user is unable to securely connect to the Internet or otherwise securely to the aforementioned remote server as aforementioned, an independent Intermediate Portable Device (IPD) will be available that would itself already have been separately securely configured using the camera's aforementioned public and private key system and then when the camera needs to be configured the IPD would connect to the camera using the camera's aforementioned public and private key system and the IPD would then securely configure the camera; In most camera model(s) such/similar a PKI system would also enable secure data transfer over the Internet or otherwise between the camera and other cameras or devices;
F.
With image tampering within—or otherwise stealing the identity of—the camera virtually eliminated, some camera models will have features to reasonably eliminate image manipulation outside the camera; Such features will be selected from the group comprising of: the use (at dynamic points of time in course of capturing the images and/or videos along with associated data) of depth sensors, radio waves, laser, multi- (at least two) angled optical images, and others reasonably allied;
G.
In some camera models, to prevent attempts to break open the SMH and reverse engineer the memory content in the chips (including but not limited to for purposes of accessing the stored keys C/S-UCEP and PK2; embedded machine code), such camera models would be programmed that memory content (usually in particular C/S-UCEP and PK2, in some camera models embedded machine code (also or instead)) would be erased upon detecting an SMH puncture; To prevent hackers from allowing the battery to run dry before attempting breaking into the SMH to access the memory contents some camera models would be programmed such that when their internal battery's voltage/power falls below a specified highly low voltage/power threshold and not recharged within a specified short period of time the memory content (usually in particular C/S-UCEP and PK2, in some camera models embedded machine code (also or instead)) would be erased; In some camera models where an external battery would be the primary power source there would be a backup low power internal battery that would delete memory content (usually in particular C/S-UCEP and PK2, in some camera models embedded machine code (also or instead)) when the external battery's voltage/power falls below a specified highly low voltage/power threshold and isn't recharged within a specified short period of time; In such instances the camera's memory content can be securely remotely restored if no tamper is detected;
H.
In some camera models, the DSG of selected images and/or videos along with any associated data will be transferred over a secure connection over mobile/satellite phone and/or otherwise over the Internet to remote trusted server(s) and stamped with time and calendar date there; Since collision free message digests cannot be reverse engineered, the time and calendar date stamped DSG strings at the designated, trusted server(s) would prove the existence of the image/video data along with any associated data linked with those DSGs at times and calendar dates at least as early as the corresponding times and calendar dates stamped on those DSGs at the designated server(s);
Note #1
Combinations of all reasonable morphs/variations/renditions/forms/flavors of “A.” through “H.” as together applied towards this claim along similar lines as defined aforementioned from the beginning of this claim are also within the scope of this claim;
Note #2
If any sub-component of the plurality of technologies in “A.” through “H.” is (then, or otherwise) already patented (that latter is or would be valid (i.e. not expired, withdrawn, etc)) by other than this inventor/applicant (and/or any future assignee(s) on this invention) then the scope of this claim only when such technology/technologies is/are used per this claim would be, in lawful reasonableness, as new use and/or improvement use;
Note #3
Because, in actual effect, including but not limited to in as much as the lawful scope of this invention (and hence of this claim), nothing substantively new has been added to these claims and to the specifications of the invention in this patent application than were already expressly or reasonably implicitly included in the aforesaid original patent application (PCT International Application No. PCT/IB2009/052392 filed with RO/IB on 5 Jun. 2009) and in the latter's priority document (USPTO Provisional Patent Application No. 61059769 filed on 8 Jun. 2008), this patent application is lawfully no less eligible to be processed either as a national phase PCT application or a continuation (or equivalent) application than as a continuation-in-part (or equivalent) application, appropriate to the laws of the respective nations;

2. The core method and otherwise features in claim 1, mutatis mutandis, applied to guarantee the authenticity of all additional claimed measurable facts of the circumstances of a particular photo or video along with any associated data (e.g. it will accurately authenticate the claimed geographical location or the claimed conditions of altitude or temperature or pressure or loudness or light or virtually anything else that can be measured), or any other type of data captured with any applicable corresponding type of device;

3. The core method and otherwise features in claim 1, mutatis mutandis, applied to render any object or space tamper proof;
